(19) United States
(12) Patent Application Publication
(10) Pub. No.: US 2022/0284172 A1
(43) Pub. Date: Sep. 8, 2022

(54) MACHINE LEARNING TECHNOLOGIES FOR STRUCTURING UNSTRUCTURED DATA

(71) Applicant: NeoCova Corporation, St. Louis, MO (US)

(72) Inventor: Maxwell Brian Rebo, Brooklyn, NY (US)

(21) Appl. No.: 17/684,880

(22) Filed: Mar. 2, 2022

Related U.S. Application Data
(60) Provisional application No. 63/157,265, filed on Mar. 5, 2021.

(51) Int. Cl. G06F 40/126; G06N 5/00; G06N 3/04; G06F 40/166

(52) U.S. Cl. CPC G06F 40/126; G06N 5/003; G06N 3/0445; G06F 40/166

(57) ABSTRACT

Technologies for formatting textual data include a computing device that obtains a string and generates a set of features by encoding the string according to an encoding scheme. Encoding the string may include assigning a character type and an indication of the character value to each character. The computing device inputs the features to a machine learning model, which outputs an indication of a modification to the string that the computing device may apply to the string. The computing device may generate simulated modifications using a Monte Carlo tree search simulation and include the simulation results in the set of features. The computing device may generate features for input data, input those features to a machine learning model that outputs a modification to the input data, and apply the modification to generate data according to a target schema. Other embodiments are described and claimed.

### CROSS-REFERENCE TO RELATED APPLICATION

The present application claims priority under 35 U.S.C. § 119(e) to U.S. Provisional Application Ser. No. 63/157,265, filed Mar. 5, 2021, the entire disclosure of which is hereby incorporated by reference.

### FIELD

This application relates generally to machine learning techniques for structuring unstructured data. For example, machine learning techniques described herein may take in unstructured data (e.g., phone numbers for various individuals) and output the data formatted into a data structure (e.g., organized according to a schema).

### BACKGROUND

An institution may store data digitally using computer data storage. The computer data storage may include storage hardware. For example, the storage hardware may include a hard disk drive (HDD), a solid state drive (SSD), or other storage device. A system may store information in the computer data storage. For example, an Internet website may store personal information about users registered with the website in data files in the computer data storage. The data files may include information such as username, first name, last name, email address, phone number, address, and/or other information about the users.

### SUMMARY

According to one aspect of the disclosure, a computing device for automatically formatting textual data includes an encoder and a string modification system. The encoder is to obtain a first string comprising a first plurality of characters and generate a first set of features by encoding of the first plurality of characters according to an encoding scheme. The first set of features is indicative of, for each character of the first plurality of characters, a character type and a character value. The string modification system is to input the first set of features to a machine learning model to generate output indicative of a first modification to the first string, and apply the first modification to the first string to generate a second string comprising a second plurality of characters.

In an embodiment, the string modification system is further to determine whether a stop criteria is met in response to application of the first modification. In response to a determination that the stop criteria is not met, the encoder is to generate a second set of features by encoding of the second plurality of characters according to the encoding scheme, and the string modification system is to input the second set of features to the machine learning model to generate output indicative of a second modification to the second string, and to apply the second modification to the second string to generate a third string.

In an embodiment, to generate the first set of features further comprises to perform a Monte Carlo tree search simulation to generate a simulated modification to the first input string and a score associated with the simulated modification, wherein the first set of input features is further indicative of the simulated modification and the score associated with the simulated modification.

In an embodiment, the encoder is further to obtain an indication of a target format for the input string; wherein to generate the first set of features further comprises to generate the first set of features by encoding of the target format according to the encoding scheme. In an embodiment, the first modification is selected from a plurality of modifications including removal of a character of the input string, insertion of a character into the input string, and moving of a character from one location in the input string to another location in the input string.

In an embodiment, to encode the first plurality of characters according to the encoding scheme comprises, for each character of the first plurality of characters, to assign a character type of a plurality of character types to the character. In an embodiment, the plurality of character types comprises a numerical digit, a lowercase letter, an uppercase letter, a space, or a period. In an embodiment, to encode the first plurality of characters further comprises, for each character of the first plurality of characters, to generate a vector that includes an indication of the character type assigned to the character and an indication of the character value of the character. In an embodiment, the vector comprises a two-hot encoded binary vector including a first set bit indicative of the character type and a second set bit indicative of the character value.

In an embodiment, the machine learning model comprises a machine learning model trained to reformat phone number data. In an embodiment, the machine learning model comprises a machine learning model trained to reformat name data. In an embodiment, the machine learning model comprises a neural network. In an embodiment, the machine learning model comprises a Neural Turing Machine (NTM).

According to another aspect, a method for automatically formatting textual data comprises obtaining, by a computing device, a first string comprising a first plurality of characters; generating, by the computing device, a first set of features by encoding the first plurality of characters according to an encoding scheme, wherein the first set of features is indicative of, for each character of the first plurality of characters, a character type and a character value; inputting, by the computing device, the first set of features to a machine learning model to generate output indicative of a first modification to the first string; and applying, by the computing device, the first modification to the first string to generate a second string comprising a second plurality of characters.

In an embodiment, the method further comprises determining, by the computing device, whether a stop criteria is met in response to applying the first modification; and in response to determining that the stop criteria is not met: generating, by the computing device, a second set of features by encoding the second plurality of characters according to the encoding scheme; inputting, by the computing device, the second set of features to the machine learning model to generate output indicative of a second modification to the second string; and applying, by the computing device, the second modification to the second string to generate a third string.

In an embodiment, generating the first set of features further comprises performing a Monte Carlo tree search simulation to generate a simulated modification to the first input string and a score associated with the simulated modification, wherein the first set of input features is further indicative of the simulated modification and the score associated with the simulated modification.

In an embodiment, the method further comprises obtaining, by the computing device, an indication of a target format for the input string; wherein generating the first set of features further comprises generating the first set of features by encoding the target format according to the encoding scheme. In an embodiment, the first modification is selected from a plurality of modifications including removal of a character of the input string, insertion of a character into the input string, and moving of a character from one location in the input string to another location in the input string.

In an embodiment, encoding the first plurality of characters according to the encoding scheme comprises, for each character of the first plurality of characters, assigning a character type of a plurality of character types to the character. In an embodiment, the plurality of character types comprises a numerical digit, a lowercase letter, an uppercase letter, a space, or a period. In an embodiment, encoding the first plurality of characters further comprises, for each character of the first plurality of characters, generating a vector including an indication of the character type assigned to the character and an indication of the character value of the character. In an embodiment, the vector comprises a two-hot encoded binary vector including a first set bit indicative of the character type and a second set bit indicative of the character value.

In an embodiment, the machine learning model comprises a machine learning model trained to reformat phone number data. In an embodiment, the machine learning model comprises a machine learning model trained to reformat name data. In an embodiment, the machine learning model comprises a neural network. In an embodiment, the machine learning model comprises a Neural Turing Machine (NTM).

According to another aspect, a computing device for automatically formatting data into a target schema includes an encoder and a structure modification system. The encoder is to select a first portion of a first textual data, wherein the first portion comprises a plurality of characters, and generate a first set of features by encoding of the first portion according to an encoding scheme. The first set of features is indicative of, for each character of the first portion, a character type and a character value. The structure modification system is to input the first set of features to a machine learning model to generate output indicative of a first modification to the first textual data, and apply the first modification to the first textual data to generate a second textual data in the target schema. In an embodiment, to apply the first modification comprises to store the first portion in a first field of the second textual data, wherein the target schema is indicative of the first field.

In an embodiment, the encoder is further to obtain an indication of the target schema. To generate the first set of features further comprises to generate the first set of features with the indication of the target schema. In an embodiment, the indication of the target schema comprises an indication of at least one field in the target schema and an indication of at least one format for the at least one field. In an embodiment, the indication of the at least one format uses an encoding scheme. In an embodiment, the encoding scheme assigns each of a plurality of character types to a respective character. In an embodiment, the plurality of character types comprises a numerical digit, a lowercase letter, an uppercase letter, a space, or a period.

In an embodiment, the computing device further comprises a string modification system to input the first set of features to the machine learning model to generate output indicative of a first modification to the first portion and to apply the first modification to the first portion to generate a second portion of textual data in a format of the target schema.

In an embodiment, the first textual data is in a first schema different from the target schema. In an embodiment, the target schema comprises a JSON schema.

In an embodiment, the machine learning model comprises a neural network. In an embodiment, the machine learning model comprises a Neural Turing Machine (NTM).

In an embodiment, to generate the first set of features further comprises to perform a Monte Carlo tree search simulation to generate a simulated modification to the first textual data and a score associated with the simulated modification. The first set of input features is further indicative of the simulated modification and the score associated with the simulated modification.

In an embodiment, the structure modification system is further to determine whether a stop criteria is met in response to application of the first modification. In response to determining that the stop criteria is not met, the encoder is to select a second portion of the first textual data and generate a second set of features by encoding of the second portion according to the encoding scheme, and the structure modification system is to input the second set of features to the machine learning model to generate output indicative of a second modification to the first textual data and apply the second modification to the first textual data to generate the second textual data in the target schema.

According to another aspect, a method for automatically formatting data into a target schema comprises selecting, by the computing device, a first portion of a first textual data, wherein the first portion comprises a plurality of characters; generating, by the computing device, a first set of features by encoding the first portion according to an encoding scheme, wherein the first set of features is indicative of, for each character of the first portion, a character type and a character value; inputting, by the computing device, the first set of features to a machine learning model to generate output indicative of a first modification to the first textual data; and applying, by the computing device, the first modification to the first textual data to generate a second textual data in the target schema. In an embodiment, applying the first modification comprises storing the first portion in a first field of the second textual data, wherein the target schema is indicative of the first field.

In an embodiment, the method further comprises obtaining, by the computing device, an indication of the target schema, wherein generating the first set of features further comprises generating the first set of features with the indication of the target schema. In an embodiment, the indication of the target schema comprises an indication of at least one field in the target schema and an indication of at least one format for the at least one field. In an embodiment, the indication of the at least one format uses an encoding scheme. In an embodiment, the encoding scheme assigns each of a plurality of character types to a respective character. In an embodiment, the plurality of character types comprises a numerical digit, a lowercase letter, an uppercase letter, a space, or a period.

In an embodiment, inputting the first set of features comprises inputting the first set of features to the machine learning model to generate output indicative of a first modification to the first portion; and applying the first modification comprises applying the first modification to the first portion to generate a second portion of textual data in a format of the target schema.

In an embodiment, the first textual data is in a first schema different from the target schema. In an embodiment, the target schema comprises a JSON schema.

In an embodiment, the machine learning model comprises a neural network. In an embodiment, the machine learning model comprises a Neural Turing Machine (NTM).

In an embodiment, generating the first set of features further comprises performing a Monte Carlo tree search simulation to generate a simulated modification to the first textual data and a score associated with the simulated modification. The first set of input features is further indicative of the simulated modification and the score associated with the simulated modification.

In an embodiment, the method further comprises determining, by the computing device, whether a stop criteria is met in response to applying the first modification; and in response to determining that the stop criteria is not met: selecting, by the computing device, a second portion of the first textual data; generating, by the computing device, a second set of features by encoding the second portion according to the encoding scheme; inputting, by the computing device, the second set of features to the machine learning model to generate output indicative of a second modification to the first textual data; and applying, by the computing device, the second modification to the first textual data to generate the second textual data in the target schema.

### BRIEF DESCRIPTION OF THE DRAWINGS

Various aspects and embodiments will be described herein with reference to the following figures. It should be appreciated that the figures are not necessarily drawn to scale. Items appearing in multiple figures are indicated by the same or a similar reference number in all the figures in which they appear.

FIG. 1A is a block diagram of a string modification system, according to some embodiments of the technology described herein.

FIG. 1B is a block diagram of a structure modification system, according to some embodiments of the technology described herein.

FIG. 2 is a flowchart of an example process for formatting a string, according to some embodiments of the technology described herein.

FIG. 3 is a flowchart of an example process for formatting data into a target structure, according to some embodiments of the technology described herein.

FIG. 4 is a flowchart of an example process for formatting a portion of textual data into a target schema, according to some embodiments of the technology described herein.

FIG. 5A is an illustration of a first string being formatted using some embodiments of the technology described herein.

FIG. 5B is an illustration of a second string being formatted using some embodiments of the technology described herein.

FIG. 6A illustrates an example of a target schema, according to some embodiments of the technology described herein.

FIG. 6B illustrates an example of data that is to be structured into the target schema of FIG. 6A, according to some embodiments of the technology described herein.

FIG. 6C illustrates a structuring of the data of FIG. 6B into the target schema of FIG. 6A using some embodiments of the technology described herein.

FIG. 7 is a block diagram of a machine learning model, according to some embodiments of the technology described herein.

FIG. 8 is a diagram illustrating an example structure of a string and/or structure modification system 800, according to some embodiments of the technology described herein.

FIG. 9 is a block diagram of an example computer system, according to some embodiments of the technology described herein.

### DETAILED DESCRIPTION OF THE DRAWINGS

The inventors have recognized that systems may store data without any consistent formatting or structure. For example, a system may store phone numbers for users in different formats including a first format in which the number is stored only as a set of ten numbers and a second format which includes other characters such as dashes and parenthesis. In another example, a system may store usernames, names, emails, and phone numbers for users in a list, where each entry of the list stores information in a different order. When large amounts of data (e.g., terabytes of data) are stored without adherence to any format or structure, the data may become difficult to use for a computer system.

The inventors have recognized that systems that use data stored by a system may operate more efficiently when the data is consistently formatted and stored in a predictable structure (e.g., a schema). This may allow the system to reliably access the data using programmatic instructions. A software application of the system may: (1) identify data in the database according to a schema that the data is organized in; and (2) obtain data in a recognized format. The system may eliminate computations required to search through unstructured data to find information and/or eliminate a need for the system to be designed such that it can handle multiple different formats and/or structures of data. For example, if all phone numbers in a database were stored in a consistent format, a web application that is to display the phone numbers in the format would not be required to reformat the phone numbers.

Accordingly, the inventors have developed techniques that employ machine learning models to automatically format any string into a desired format. The system generates input features for a machine learning model using an encoding scheme to represent the string. The system provides the generated input features to a machine learning model to obtain output indicating a modification to apply to the string. In some embodiments, to format a string into a desired format, the system may iteratively: (1) generate input features; (2) provide the input features to the machine learning model to obtain output indicating a modification; and (3) apply the modification indicated by the output of the machine learning model.

Furthermore, the inventors have developed techniques that employ machine learning models to automatically structure data. The techniques described herein may be used to automatically format data into a target structure (e.g., schema). The system uses data that is to be formatted into a target structure to generate input features for a machine learning model. The system provides the input features to the machine learning model to obtain output indicating a modification for formatting the data into the target structure. In some embodiments, the output may indicate one or more fields of a target schema in which values in the data are to be stored. The system may then write the data formatted into the target structure into storage (e.g., one or more data files). For example, the system may write values from the data into a data file that adheres to a target schema.

Some embodiments described herein address all the above-described issues that the inventors have recognized with conventional data storage. However, it should be appreciated that not every embodiment described herein addresses every one of these issues. It should also be appreciated that embodiments of the technology described herein may be used for purposes other than addressing the above-discussed issues of data storage.

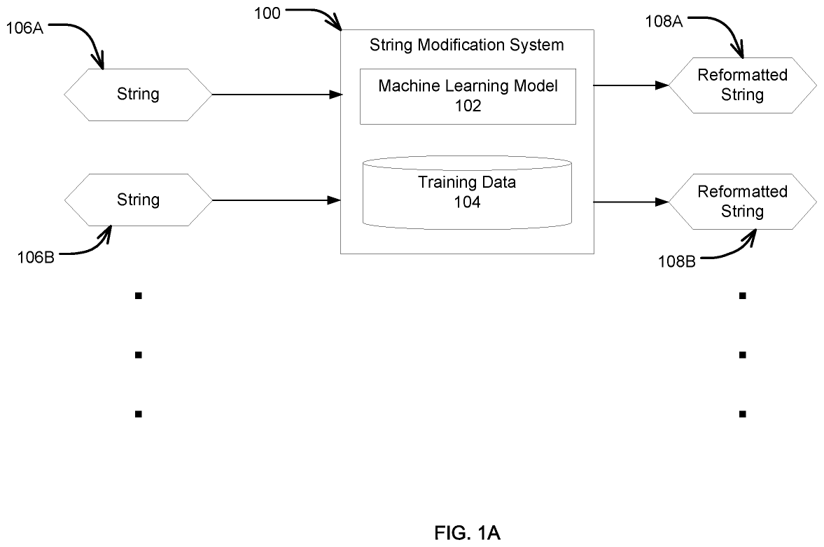

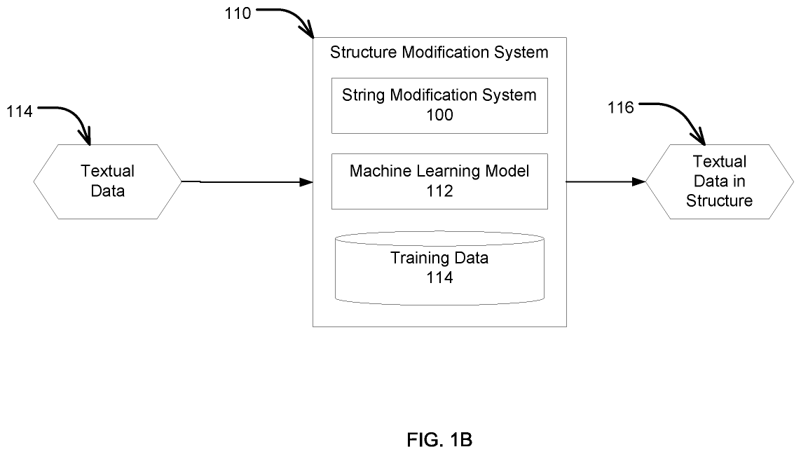

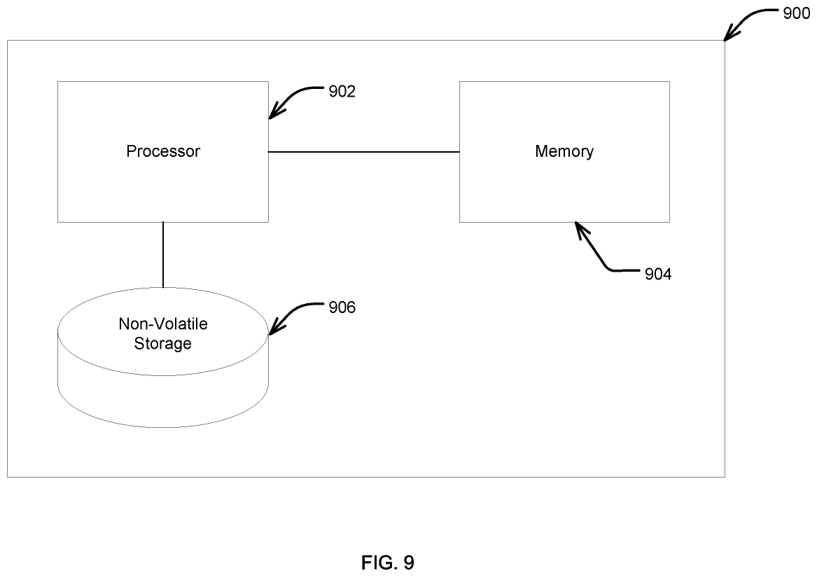

FIG. 1A is a block diagram of a string modification system 100, according to some embodiments of the technology described herein. The string modification system 100 may be a computing device. For example, the string modification 100 may be computing device 900 described herein with reference to FIG. 9.

As shown in the example embodiment of FIG. 1A, the string modification system 100 includes a machine learning model 102. In some embodiments, the machine learning model 102 may include a neural network. For example, the machine learning model 102 may include a recurrent neural network (RNN), a convolutional neural network (CNN), a transformer neural network, and/or any other suitable neural network. In some embodiments, the machine learning model 102 may be a neural Turing machine (NTM).

In some embodiments, the string modification system 100 may be configured to use the machine learning model 102 to automatically format a string. The string modification system 100 may be configured to obtain a string (e.g., string 1 106A and/or string 2 106B) and generate a set of features using the string. In some embodiments, the string modification system 100 may be configured to generate the set of features using the string by encoding each of one or more characters of the string using an encoding scheme to generate the set of features. The string modification system 100 may be configured to provide the generated set of features as input to the machine learning model 102 to obtain output indicating a modification to the string. The string modification system 100 may be configured to apply the modification to the string.

In some embodiments, the string modification system 100 may be configured to iteratively determine modifications to the string using the machine learning model 102. The string modification system 100 may be configured to: (1) obtain a string; (2) generate a set of features for the string; (3) provide the set of features as input to the machine learning model 102 to obtain an indication of a modification to the string; and (4) apply the modification to the string. The string modification system 100 may be configured to iteratively perform steps (1) to (4) on the obtained modified strings. In some embodiments, the string modification system 100 may be configured to iterate until the string modification system 100 determines that a condition is met. In some embodiments, the string modification system 100 may be configured to iterate until the string modification system 100 determines that a threshold score is obtained. For example, the string modification system 100 may iterate until a string obtained from the most recently executed iteration is within a threshold distance of a target format for the string. In some embodiments, the string modification system 100 may be configured to iterate until the string modification system 100 has determined that the string modification system 100 has iterated for a threshold period of time. In some embodiments, the string modification system 100 may be configured to iterate until the string modification system 100 has performed a threshold number of iterations.

In some embodiments, the string modification system 100 may be configured to generate a set of features for a string using an encoding scheme. In some embodiments, the string modification system 100 may be configured to encode, for each character of the string: (1) an indication of whether the character is a digit; (2) an indication of whether the character is lowercase; (3) an indication of whether the character is uppercase; (4) an indication of whether the character is a space; (5) an indication of whether the character is a period; (6) an indication of whether the character is a character other than a digit, letter, space, or period; and (7) for each of a set of candidate characters (e.g., ASCII characters), an indication of whether the character is the candidate character. In some embodiments, the string modification system 100 may be configured to generate a vector indicating the encoding for a character. For example, the vector may be a two-hot encoded binary vector prefixed with character type Boolean values as follows: [IS_DIGIT, IS_LOWERCASE, IS_UPPERCASE, IS_SPACE, IS_PERIOD, IS_OTHER, is_char_1, is_char_2, . . . is_char_n]. In some embodiments, characters 1 to n may be Booleans associated with respective ASCII characters. The string modification system 100 may be configured to generate a vector for each character in the string. The string modification system 100 may be configured to provide the vector for one or more characters as input to the machine learning model 102 to obtain output indicating one or more modifications to the string.

In some embodiments, the string modification system 100 may be configured to obtain a specification of a target format that a string is to be formatted into. In some embodiments, the string modification system 100 may be configured to use an indication of a character type sequence that the reformatted string should have. In some embodiments, the character types may include digit, lowercase letter, uppercase letter, space, period, and other. The string modification system 100 may be configured to indicate each character type with a respective character. For example, “I” may represent digit, “L” may represent lowercase letter, “U” may represent uppercase letter, “S” may represent a space, “P” may represent a period, and “O” may represent other. The string modification system 100 may be configured to use these character type designations to specify a target format for a string. For example, the string modification system 100 may indicate that a target output format for a string is “IIIIIIIII”, which indicates a sequence of 10 digits (e.g., for a phone number). In some embodiments, the string modification system 100 may be configured to use an operator to indicate any number of characters of the previously specified character type. For example, the string modification system 100 may use a “*” as the operator. As an illustrative example, “U*I” may indicate the following sequence: (1) an uppercase letter; (2) any number of uppercase letters; (3) and a digit. In some embodiments, the string modification system 100 may be configured to provide an indication of a character type sequence as input to the machine learning model 102.

In some embodiments, the machine learning model 102 may be configured to output an indication of a modification from a plurality of modifications that can be applied to a string (e.g., at each iteration). In some embodiments, the plurality of modifications may include removal of a character, insertion of a character, and moving of a character. In some embodiments, the plurality of modifications may indicate an index of a location in the string at which to apply the modification. For example, the plurality of modifications may include removal of a character at a location in the string, insertion of a character at a location in the string, and moving a character at one location in the string to another location in the string. In some embodiments, location may be indicated by an index. For example, an index of 0 may indicate the 1^{st} character of the string, and an index of 3 may indicate the 4^{th} character in the string. In some embodiments, the string modification system 100 may be configured to apply the modification indicated by the output of the machine learning model 102.

As shown in the example embodiment of FIG. 1A, the string modification system 100 receives strings 106A-106B as inputs. The string modification system 100 reformats string 106A into reformatted string 108A and string 106B into reformatted string 108B. In some embodiments, each of string strings 106A-106B may be in a different format. For example, string 106A may be a first phone number “401-345-3344”, and string 106B may be a second phone number “5083334441”. The string modification system 100 may be configured to reformat the first string 106A and the second string 106B into a single output format. Accordingly, reformatted string 108A may have the same format as reformatted string 108B. For example, reformatted string 108A may be “(401) 345 3344” and reformatted string 108B may be “(508) 333 4441”.

Although the example embodiment of FIG. 1A shows two strings 106A-B being formatted, in some embodiments, the string modification system 100 may be configured to reformat any number of strings as indicated by the three dotted lines under the strings 106A-B. The string modification system 100 may be configured to output a corresponding number of reformatted strings as indicated by the three dotted lines under reformatted strings 108A-B.

In some embodiments, the string modification system 100 may be configured to: (1) predict a result of performing one or more modifications to the string; and (2) generate one or more of a set of input features using the predicted result. In some embodiments, the string modification system 100 may be configured to simulate one or more modifications applied to the string, and use the simulation to generate one or more input features. For example, the string modification system 100 may use a Monte Carlo search to simulate performance of one or more modifications to the string. The system may use the results of the Monte Carlo search to determine the feature(s). For example, the system may determine values in a feature vector indicating results of one or more simulated modifications to the string. In some embodiments, the string modification system 100 may be configured to determine a score associated with one or more modifications from Monte Carlo search. The string modification system 100 may be configured to use the score as an input feature to be provided to the machine learning model 102.

As shown in the example embodiment of FIG. 1A, the string modification system 100 includes training data 104. The string modification system 100 may be configured to use the training data to train the machine learning model 102. In some embodiments, the string modification system 100 may be configured to apply a supervised learning technique to the training data 104 to train the machine learning model 102. For example, the string modification system 100 may perform stochastic gradient descent to train the machine learning model 102. The string modification system 100 may iteratively (1) provide inputs to the machine learning model 102 to obtain outputs; (2) determine a difference between the outputs and the expected outputs; and (3) update parameters of the machine learning model 102 based on the difference. For example, the string modification system 100 may use a loss function to evaluate a difference between the outputs from the machine learning model and the expected outputs. In some embodiments, the string modification system 100 may be configured to apply an unsupervised learning technique to the training data 104 to train the machine learning model 102. For example, the string modification system 100 may be configured to perform k-means clustering using the training data 104 to train the machine learning model 102.

In some embodiments, the machine learning model 102 may be trained to output indications of modifications of strings to achieve a target format. For example, the machine learning model 102 may be trained to format any phone number into a target format (e.g., of a sequence of 10 digits). In another example, the machine learning model 102 may be trained to format names into a target format (e.g., a first name and a last name each beginning with an uppercase letter). In some embodiments, the machine learning model 102 may be trained to output indications of modifications of strings to achieve multiple different target formats. For example, the machine learning model 102 may be trained to: (1) output indications of modifications to phone number data to achieve a target format for phone numbers; and (2) output indications of modifications to name data to achieve a target format for the names.

In some embodiments, the string modification system 100 may be configured to generate training data for use in training the machine learning model 102. The string modification system 100 may be configured to: (1) generate a set of strings; and (2) generate a set of reformatted strings using the set of strings. The system 100 may be configured to use the strings and reformatted strings as training data for training the machine learning model 102 to determine modifications to the data such that the data will meet a target structure (e.g., schema).

In some embodiments, the string modification system 100 may be configured to train the machine learning model 102 with increasing levels of difficulty. For example, the string modification system 100 may train the machine learning model 102 with a first set of training data having a first level randomness, and subsequently train the machine learning model 102 may a second set of training data having a second level of randomness. The string modification system 100 may thus incrementally train the machine learning model 102 such that it may be used to format input strings of greater difficulty.

FIG. 1B is a block diagram of a structure modification system 110, according to some embodiments of the technology described herein. Structure modification system 110 may be any suitable computing device. For example, structure modification system 110 may be computing device 900 described herein with reference to FIG. 9.

As shown in the example embodiment of FIG. 1B, the structure modification system 110 includes a machine learning model 112. In some embodiments, the machine learning model 112 may include a neural network. For example, the machine learning model 112 may include a recurrent neural network (RNN), a convolutional neural network (CNN), a transformer neural network, and/or any other suitable neural network. In some embodiments, the machine learning model 112 may be a neural Turing machine (NTM).

In some embodiments, the structure modification system 110 may be configured to obtain a set of data (e.g., textual data) 114. The structure modification system 110 may be configured to format the data 114 into a target structure. For example, the structure modification system 110 may format the data 114 into a target schema. In some instances, the data 114 may not have any structure. For example, the data 114 may not adhere to a schema. In some instances, the data 114 may be in a structure different than the target structure. For example, the data 114 may have a schema different from a target schema.

In some embodiments, the structure modification system 110 may be configured to use the machine learning model 112 to format the textual data 114 into the target structure. In some embodiments, the structure modification system 110 may be configured to iteratively format portions (e.g., segments) of the data 114 into the target structure to obtain the output data 116 in the target structure. The structure modification system 110 may be configured to: (1) select a portion of the data 114; (2) generate a set of features using the selected portion of the data 114; (3) provide the set of features as input to the machine learning model 112 to obtain output indicating a set of data in the target structure (e.g., schema); and (4) write the set of data in the target structure to the output 116. In some embodiments, the structure modification 110 may be configured to iterate until the structure modification 110 has finished formatting the data 114 into the target structure. For example, the data 114 may be one or more data files. In this example, the structure modification system 110 may iterate until the contents of the data file(s) have been formatted into the target structure.

In some embodiments, the machine learning model 112 may be configured to output an indication of a location in an output data set in which at least some of the portion of the data 114 is to be stored. In some embodiments, the machine learning model 112 may be configured to output an indication of a field of a target schema in which the portion (or part of the portion) is to be stored. For example, the machine learning model 112 may output an indication of a field in which a phone number in the portion of the data 114 is to be stored. In another example, the machine learning model 112 may output an indication of a field in which a person's name is to be stored.

In some embodiments, the structure modification system 110 may be configured to obtain an indication of the target structure. For example, the structure modification system 110 may obtain an indication of a target schema (e.g., a JSON, XML, YAML, RDF, or other type of structure) that the data 114 is to be formatted into. The indication of the target schema may include one or more fields and an indication of a format of data for each of the field(s). In some embodiments, the indication of the format may employ an encoding scheme. For example, the indication of the format may use the encoding scheme used by the string modification system 100 for specifying a format for a string described herein with reference to FIG. 1A. The encoding scheme may assign each of multiple character types to a respective character. The character types may include numerical digit (e.g., indicated by “I”), lowercase letter (e.g., indicated by “L”), uppercase letter (e.g., indicated by “U”), space (e.g., indicated by “S”), period (e.g., indicated by “P”), and other (e.g., indicated by “O”).

As shown in the example embodiment of FIG. 1B, the structure modification system 110 includes the string modification system 100. In some embodiments, the structure modification system 110 may be configured to use the string modification system 100. The structure modification system 110 may be configured to use the string modification system 100 to format one or more strings in the data 114 into a target format. In some embodiments, the structure modification system 110 may be configured to use the string modification system 100 to format the string(s) into a target format indicated by a target schema. For example, the target schema may indicate that phone numbers associated with a user are to be formatted as 10 numbers (e.g., “IIIIIIIIII”) In this example, the structure modification system 110 may be configured to use the string modification system 100 to format one or more phone numbers in the data 114 into the target format.

As shown in the example embodiment of FIG. 1B, the structure modification system 110 includes training data 114. The structure modification system 104 may be configured to use the training data 114 to train the machine learning model 112. In some embodiments, the structure modification system 110 may be configured to apply a supervised learning technique to the training data 114 to train the machine learning model 112. For example, the structure modification system 110 may perform stochastic gradient descent to train the machine learning model 112. The structure modification system 110 may iteratively (1) provide inputs to the machine learning model 102 to obtain outputs; (2) determine a difference between the outputs and the expected outputs; and (3) update parameters of the machine learning model 102 based on the difference. For example, the structure modification system 110 may use a loss function to evaluate a difference between the outputs from the machine learning model and the expected outputs. In some embodiments, the structure modification system 110 may be configured to apply an unsupervised learning technique to the training data 114 to train the machine learning model 112. For example, the structure modification system 110 may be configured to perform k-means clustering using the training data 114 to train the machine learning model 112.

In some embodiments, the structure modification system 110 may be configured to generate training data for use in training the machine learning model 112. The structure modification system 110 may be configured to generate unstructured data, and use the generated unstructured data to train the machine learning model 112 to determine modifications to the data such that the data will meet a target structure (e.g., schema).

In some embodiments, the structure modification system 110 may be configured to train the machine learning model 112 with increasing levels of difficulty. For example, the structure modification system 110 may train the machine learning model 112 with a first set of training data having a first level randomness, and subsequently train the machine learning model 112 may a second set of training data having a second level of randomness. The structure modification system 110 may thus incrementally train the machine learning model 112 such that it may be used to format input data of greater difficulty.

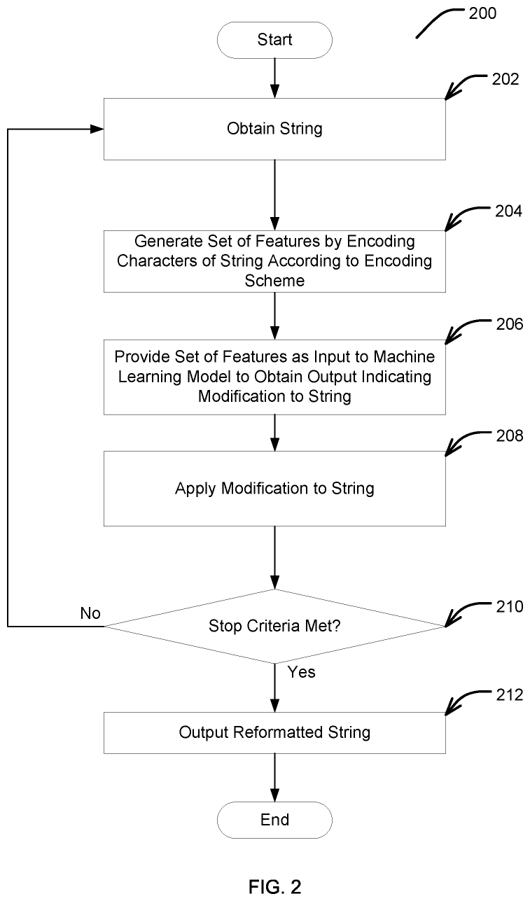

FIG. 2 is a flowchart of an example process 200 for formatting a string into a target format, according to some embodiments of the technology described herein. Process 200 may be performed by any suitable computing device. For example, process 200 may be performed by string modification system 100 described herein with reference to FIG. 1A.

Process 200 begins at block 202, where the system obtains a string. In some embodiments, the system may be configured to obtain a string by selecting the string from a set of multiple strings. For example, the system may obtain the string from a file that includes a list of strings (e.g., phone numbers) to be reformatted. In some embodiments, the system may be configured to obtain a string by receiving the string from another system (e.g., structure modification system 110 described herein with reference to FIG. 1B). In some embodiments, the system may be configured to obtain the string by: (1) identifying a string to be reformatted (e.g., in a data file); and (2) obtaining the identified string. For example, the system may obtain a set of data files including textual data (e.g., phone numbers and/or names) that are to be reformatted. The system may obtain the string (e.g., a phone number) from the set of data files.

Next, process 200 proceeds to block 204, where the system generates a set of features by encoding characters of the string according to an encoding scheme. In some embodiments, the system may be configured to use the encoding scheme described herein with reference to FIG. 1A. For example, the system may encode the character in a vector indicating: (1) whether the character is a digit; (2) whether the character is a lowercase letter; (3) whether the character is an uppercase letter; (4) whether the character is a space; (5) whether the character is a period; (6) whether the character is a character other than a digit, a lowercase letter, an uppercase letter, a space, or a period; and (7) for each of a set of characters (e.g., ASCII characters), whether the character from the string is the ASCII character. In some embodiments, the system may be configured to use binary values to encode the character in the vector.

In some embodiments, the system may be configured to include, in the set of features, an indication of a simulation of one or more modifications to the string. For example, the system may use a Monte Carlo search tree to obtain, for each of one or more sequences of modifications to the string, a score. The system may include the one or more scores in the set of features. The Monte Carlo search tree may allow the system to simulate one or more modifications ahead of a current iteration. The results of the simulation may be used as additional input features. For example, the additional features may facilitate a machine learning model to identify an optimal subsequent modification to be applied to the string.

In some embodiments, the system may be configured to obtain an indication of a target format for the string to be formatted into. In some embodiments, the indication of the target format may be an indication of a sequence of character types that consist of the string. In some embodiments, each character type in the sequence may be one of the following: (1) a digit (e.g., 0-9); (2) a lowercase letter; (3) an uppercase letter; (4) a space; (5) a period; (6) and other character. Each character type may be indicated by a respective letter. For example, a digit may be indicated by “I”, a lowercase letter may be indicated by “L”, an uppercase letter may be indicated by “U”, a space may be indicated by “S”, a period may be indicated by “P”, and other may be indicated by “0”. As an illustrative example, the system may obtain an indication of a target format for phone numbers to be “IIISIIISIIII” which indicates a sequence of three digits, followed by a space, followed by three digits, followed by a space, followed by three digits. In some embodiments, the system may use an operator to allow for any number of character types of a previously indicate character type. For example, the system may obtain an indication of a target format for names to be “UL*SUL*” which indicates a sequence of an uppercase letter, followed by any number of lower case letters, followed by a space, followed by an uppercase letter, followed by any number of lower case letters.

In some embodiments, the system may be configured to use the indication of the target format for the string as a constraint. For example, the system may use the indication of the target format as a constraint for determining a modification to apply to the string. The system may use the indication of the target format to eliminate certain modifications that would violate the target format. In some embodiments, the system may be configured to include an indication of the target format in the set of features. For example, the system may use the encoding scheme to encode the target format and include the encoded target format in the set of input features.

Next, process 200 proceeds to block 206, where the system provides the set of features as input to a machine learning model to obtain output indicating a modification to the string. For example, the machine learning model may include a neural network (e.g., a CNN and/or RNN). In this example, the system may provide the set of input features (e.g., as a vector) as input to the neural network to obtain an output indicating a modification to the string. The machine learning model may include parameters (e.g., neural network weights) that are used by the system to determine an output of the machine learning model. In some embodiments, the output may indicate one of multiple possible modifications or no modification. For example, the output may be a classification, where the classification indicates one of multiple modifications that can be applied to the string or that no modification is to be applied.

In some embodiments, the modifications that may be indicated by the output of the machine learning model may be removal of a character from the string, insertion of a character into the string, and moving a character within the string. In some embodiments, the output may indicate a location at which to apply the modification. For example, the output may indicate: (1) an index indicating a location of a character to be removed; (2) an index indicating a location where a character is to be inserted; or (3) a pair of indices where the first index specifies a current location of the character in the string and the second index specifies a location in the string at which to place the character. In some embodiments, the modifications may include replacing a character in the string with another character. For example, the modification may indicate an index from which a character is to be removed from the string and a new character that is to be inserted at the index in the string.

In some embodiments, the machine learning model may include memory. The machine learning model may determine an output based on one or more inputs previously provided to the machine learning model and/or one or more previous outputs of the machine learning model. For example, the system may include a set of features provided as input to the machine learning model in a previous iteration (e.g., of performing blocks 202-210) in the set of features. In another example, the system may include an output obtained from a previous iteration in the set of features.

In some embodiments, the system may be configured to use a Monte Carlo search model to determine a modification to be applied to the string. The system may be configured to provide a modification indicated by the output of the machine learning model as input to the Monte Carlo search model. The Monte Carlo search model may determine modification paths to obtain a target format of the string. The system may determine a modification that the Monte Carlo search indicates is the likeliest to reach the target format of the string within a number of modifications.

Next, process 200 proceeds to block 208 where the system applies the modification indicated by the output of the machine learning model and/or the Monte Carlo search to the string. In some embodiments, the system may be configured to apply the modification by removing a character of the string, inserting a character into the string, moving a character in the string, or making no modification to the string. In some embodiments, the system may be configured to apply the modification to the string to obtain an updated string.

Next, process 200 proceeds to block 210, where the system determines whether a stop criteria is met. In some embodiments, the system may be configured to determine a score for the updated string. For example, the system may determine a score by determining a measure of difference between the updated string and a target format for the string. For example, the system may determine a number of characters in the updated string that violate the target format and determine a score based on the number of characters. In some embodiments, the system may be configured to determine an indication of a confidence associated with the updated string. For example, the system may obtain a score from the machine learning model indicating a confidence level associated with an indicated modification. In some embodiments, the system may be configured to determine whether the score meets a threshold score.

In some embodiments, the system may be configured to determine whether a stop criteria is met by determining whether the system has performed a threshold number of iterations. For example, the system may determine whether the system has performed a threshold number of modifications (e.g., 5, 10, 20, 50, 75, 100, or other number of modifications).

If the system determines that the stop criteria has not been met at block 210, then process 200 proceeds to block 202. The system performs process the steps at blocks 202 to 210 using the updated string. If the system determines that the stop criteria has been met at block 210, then process 200 proceeds to block 212, where the system outputs the formatted string. In some embodiments, the system may be configured to output the formatted string to a system that provided an initial string to be reformatted. In some embodiments, the system may be configured to output the formatted string to a data file. For example, the system may output the formatted string to a data file of formatted strings.

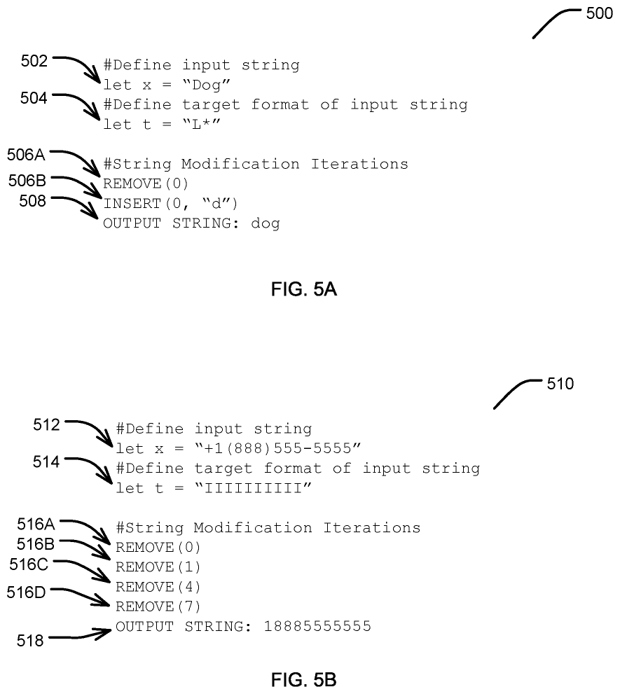

FIG. 5A is an illustration 500 of a first string 502 being formatted using some embodiments of the technology described herein. For example, FIG. 5A shows an example of string modification system 100 performing process 200 to format input string 502 into target format 504. The example of FIG. 5A shows an example of formatting a string to make all characters in the string lowercase letters. As shown in the illustration 500, the input string 502 is “Dog”. In this example, the target format 504 for the string is specified by “L*” which indicates a lowercase letter followed by any number of lowercase letters. The system performs a series of two modifications 506A-B to the string to obtain the output string 508 of “dog”. The system may be configured to obtain each modification by performing blocks 202 to 208 of process 200. For example, the system may generate a set of features from the input string 502 “Dog”, and provide the set of features as input to a machine learning model to obtain an indication of the first modification 506A to remove the first character (“D”) from the initial string 502. The system may then generate a second set of features after performing the first modification 506A. The system may provide the second set of features as input to the machine learning model to obtain an indication of the second modification 506B to insert a “d” at the beginning of the string to obtain the output string 508 “dog”.

FIG. 5B is another illustration 510 of a second string 512 being formatted using some embodiments of the technology described herein. For example, FIG. 5B may be an example of string modification system 100 performing process 200 to format the input string 512 into a target format 514. The example of FIG. 5B illustrates reformatting of a phone number into a target format 514 indicated by “IIIIIIIIIII”, which is a sequence of 11 digits. The input string 512 is “+1(888)555-5555”. The system may perform process 200 to obtain the output string 518 “18885555555”. In a first iteration the system performs a first modification 516A to remove the first character in the input string 512 to obtain “1(888)555-5555)”. Next, the system performs a second modification 516B to remove the character at index number 1 in the previously updated string to obtain “1888)555-5555”. Next, the system performs a third modification 516C to remove the character at index number 4 in the previously updated string to obtain “1888555-5555”. Lastly, the system performs a fourth modification 516D to remove the character at index 7 of the previously updated string to obtain the output string 518 of “18885555555”. The system may determine each of the modifications by performing the steps at blocks 202 to 208 of process 200.

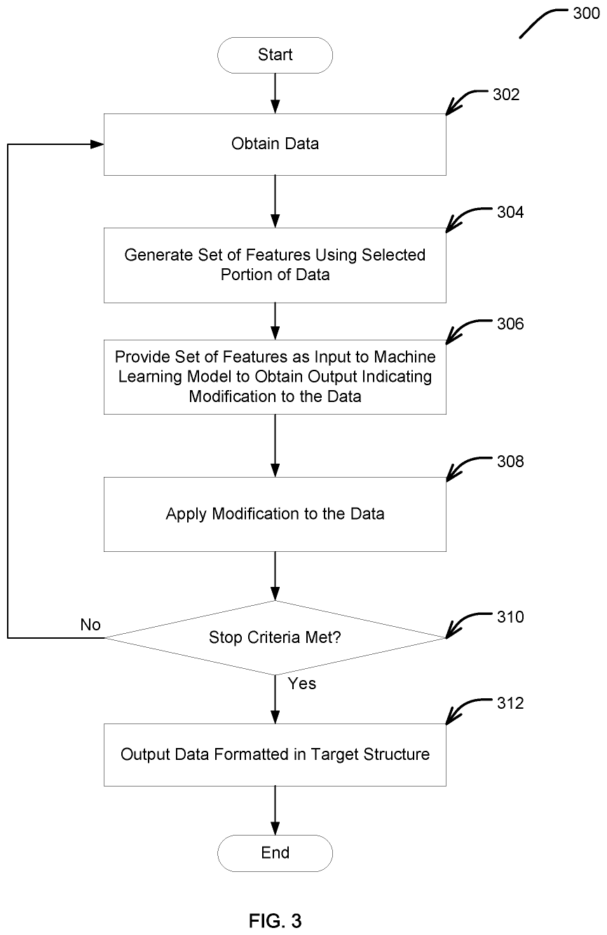

FIG. 3 is a flowchart of an example process 300 for structuring data into a target structure (e.g., a target schema), according to some embodiments of the technology described herein. Process 300 may be performed by any suitable computing device. For example, process 300 may be performed by structure modification system 110 described herein with reference to FIG. 1B.

Process 300 begins at block 302, where the system obtains data that is to be formatted into a target structure (e.g., a target schema). In some embodiments, the system may be configured to obtain the data by obtaining one or more data files. For example, the system may be provided the data file(s) from system separate from the system performing process 300 (e.g., to format the data in the file(s) into the target structure). In another example, the system may obtain the data file(s) from computer storage (e.g., from a database). In some embodiments, the data may have no structure. For example, the data may not be organized according to any schema. In some embodiments, the data may have a structure that is different from the target structure. For example, the data may be stored in a schema that is different from the target schema.

In some embodiments, the system may be configured to obtain an indication of a target structure. In some embodiments, the target structure may be a target schema that the data is to be formatted into. The system may be configured to obtain a file indicating the target schema. For example, the system may obtain a JSON file defining the target schema. In some embodiments, the indication of the target structure (e.g., a target schema) may specify one or more fields. In some embodiments, the indication of the target structure may specify a format for data in the field(s). In some embodiments, the format for a field may be indicated by a sequence of character types for a string that is to be stored in the field. In some embodiments, each character type in the sequence may be one of the following: (1) a digit (e.g., 0-9); (2) a lowercase letter; (3) an uppercase letter; (4) a space; (5) a period; (6) and other character. Each character type may be indicated by a respective letter. For example, a digit may be indicated by “I”, a lowercase letter may be indicated by “L”, an uppercase letter may be indicated by “U”, a space may be indicated by “S”, a period may be indicated by “P”, and other may be indicated by “0”. As an illustrative example, the system may obtain an indication of a target format for phone numbers to be “IIISIIISIIII” which indicates a sequence of three digits, followed by a space, followed by three digits, followed by a space, followed by three digits. In some embodiments, the system may use an operator to allow for any number of character types of a previously indicate character type. For example, the system may obtain an indication of a target format for names to be “UL*SUL*” which indicates a sequence of an uppercase letter, followed by any number of lower case letters, followed by a space, followed by an uppercase letter, followed by any number of lower case letters.

In some embodiments, the system may be configured to select a portion of the data. In some embodiments, the system may be configured to select the portion of the data by reading a predetermined amount of data. For example, the system may select the portion of the data by reading a number of lines (e.g., 1, 2, 3, 4, 5, 10, 50, or 100 lines). In some embodiments, the system may be configured to select the portion of data by reading a predetermined size of data. For example, the system may read a certain number of bytes of data from a file. In some embodiments, the system may be configured to select the portion of the data by: (1) identifying a field in the data; and (2) selecting the data in the identified field.

Next, process 300 proceeds to block 304, where the system generates a set of features using the selected portion of data. In some embodiments, the system may be configured to use an encoding scheme to generate the set of features. For example, the system may use an encoding scheme as described at block 204 of process 200. In some embodiments, the system may be configured to generate the set of features by: (1) applying the encoding scheme to determine an encoding of one or more characters in the selected portion of data; and (2) generating the set of features using the determined encoding. For example, the system may encode characters in a selected line of the data.

In some embodiments, the system may be configured to simulate one or more modifications. In some embodiments, the system may be configured to simulate the modification(s) using a Monte Carlo tree search. For example, the system may use the Monte Carlo tree search to determine one or more scores associated with the modification(s). The system may use the score(s) to determine one or more features of the set of features. For example, the system may determine the score(s) to be the feature(s).

In some embodiments, the machine learning model may include memory. The machine learning model may determine an output based on one or more inputs previously provided to the machine learning model and/or one or more previous outputs of the machine learning model. For example, the system may include a set of features provided as input to the machine learning model in a previous iteration (e.g., of performing blocks 304-310) in the set of features. In another example, the system may include an output obtained from a previous iteration in the set of features.

Next, process 300 proceeds to block 306, where the system provides the set of features as input to a machine learning model to obtain output indicating a modification to the data. In some embodiments, the machine learning model may be a neural network (e.g., a CNN, RNN, neural Turing machine, and/or other type of neural network). The output of the machine learning model may indicate a modification of the data to achieve the target structure. The system may be configured to provide the set of input features as input and, in response, output an output of the machine learning model indicative of a modification to the data. In some embodiments, the modification to the data may identify a field of a target structure (e.g., schema) in which one or more values of the data are to be stored. For example, the modification may identify a phone number field in a target schema in which the data is to be stored.

In some embodiments, the machine learning model may be trained using supervised learning techniques. For example, the machine learning model may have been trained by applying supervised learning techniques to a set of training data including input data portions and corresponding outputs. The outputs may represent reformatting of the input data into a target structure. For example, the machine learning model may be trained using stochastic gradient descent. In some embodiments, the machine learning model may be trained using unsupervised learning techniques. For example, the machine learning model may have been trained by applying unsupervised learning techniques to a set of training data. For example, the machine learning model may have been trained using k-means clustering. In some embodiments, the machine learning model may have been trained using a semi-supervised learning technique.

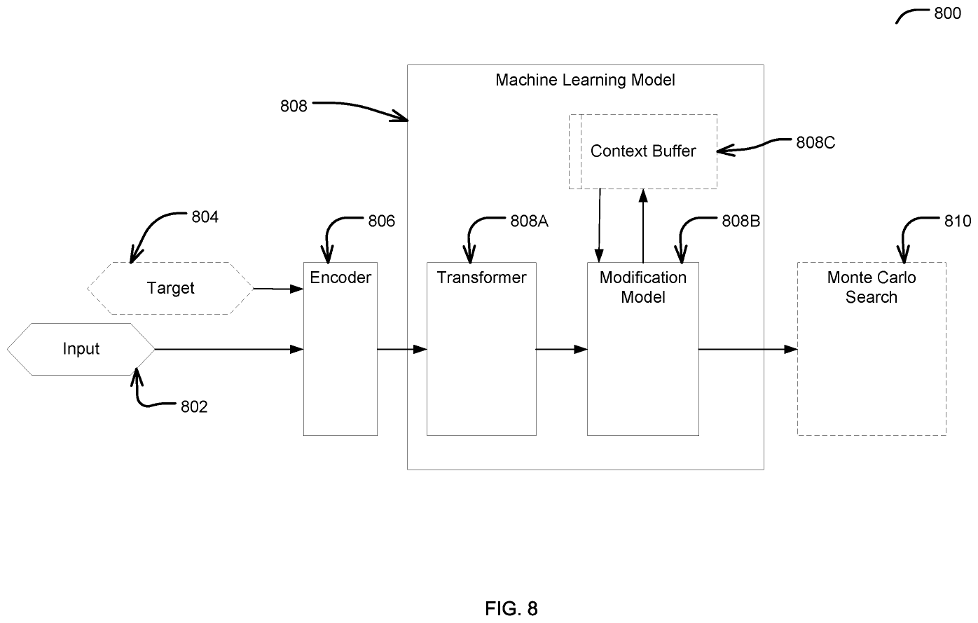

In some embodiments, the system may be configured to provide a modification indicated by an output of the machine learning model as input to a Monte Carlo search model (e.g., Monte Carlo search model 810 described with reference to FIG. 8). The Monte Carlo search model may be configured to determine a modification to be applied to the data. For example, the Monte Carlo search model may identify one or more fields of a target schema in which data is to be stored in. The Monte Carlo search model may be configured to simulate multiple paths of modification and select a modification that is predicted to have the highest likelihood (e.g., probability) of reaching a target structure (e.g., target schema) for the data.

Next, process 300 proceeds to block 308, where the system applies the modification to the data. In some embodiments, the system may be configured to use the output of the machine learning model to generate a portion of data formatted into the target structure. For example, the system may use the output of the machine learning model to generate a portion of an output data file corresponding to the portion of data selected at block 302. In some embodiments, the system may be configured to write a portion of an output file storing data in a target schema. For example, the system may write a portion (e.g., all) of a data file in the target schema. In some embodiments, the system may be configured to generate the portion of data formatted into the target structure by writing data from the selected portion to a field indicated by the output of the machine learning model and/or the Monte Carlo search model. For example, the system may write a phone number in the selected portion of data to a field designated for a phone number in the target structure (e.g., target schema).

Next, process 300 proceeds to block 310, where the system determines if a stop criteria is met. In some embodiments, the system may be configured to determine whether the system has performed a threshold number of iterations (e.g., of blocks 302-310). In some embodiments, the system may be configured to determine whether the system has completed processing a set of data. For example, the system may determine whether one or more data files have been formatted into the target data structure (e.g., the target schema). In some embodiments, the system may be configured to determine whether a score meets a threshold score. For example, the system may: (1) determine a score to be a measure of a degree to which the modified data meets the target data structure; and (2) determine whether the score meets a threshold score.

If the system determines the stop criteria is met at block 310, then process 300 proceeds to block 312, where the system outputs the data formatted into the target structure. For example, the system may output one or more data files that adhere to a target schema. In some embodiments, the system may be configured to provide the data formatted in the target structure to another system. For example, the system may transmit the data formatted in the target structure to a system from which the system obtained the data. If the system determines that the stop criteria is not met at block 310, then process 300 proceeds to block 302, where the system performs another iteration of blocks 304-310. For example, the system may apply another modification to the data and determine whether the modified data meets the stop criteria at block 310.

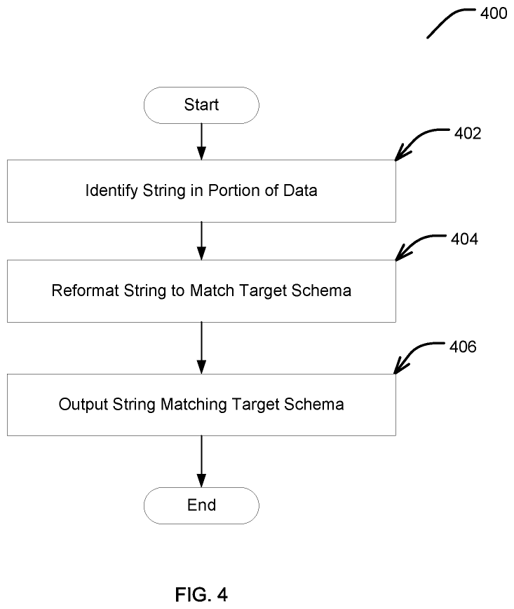

FIG. 4 is a flowchart of an example process 400 for formatting a portion of data into a target schema, according to some embodiments of the technology described herein. Process 400 may be performed by any suitable computing device. For example, process 400 may be performed by structure modification system 110 described herein with reference to FIG. 1B. In some embodiments, process 400 may be performed as part of process 300 described herein with reference to FIG. 3. For example, process 400 may be performed by the system at blocks 304-306 to format a string in data into a target format (e.g., indicated by a target schema).

Process 400 begins at block 402, where the system identifies a string in a portion of data. In some embodiments, the system may be configured to identify a string in a portion of data that is to be formatted into a target data structure. For example, the target data structure may be a target schema that indicates a format for one or more strings that are to be stored in data fields of the target schema. The system may be configured to identify a string that is to be stored in a field of the target schema according to the format.

Next, process 400 proceeds to block 404, where the system formats the string to match the target schema. In some embodiments, the system may be configured to format the string by performing process 200 described herein with reference to FIG. 2. For example, the system may perform process 200 to iteratively modify the string to obtain a string that meets a format specified by a target schema.

Next, process 400 proceeds to block 406, where the system outputs the string matching the target schema. In some embodiments, the system may be configured to output a string that is formatted according to a format indicated by the target schema. For example, the system may output a phone number that is formatted according to the target schema. In some embodiments, the system may be configured to output the string by writing the string into an output. For example, the system may be configured to write the string into an output data file (e.g., as part of process 300).

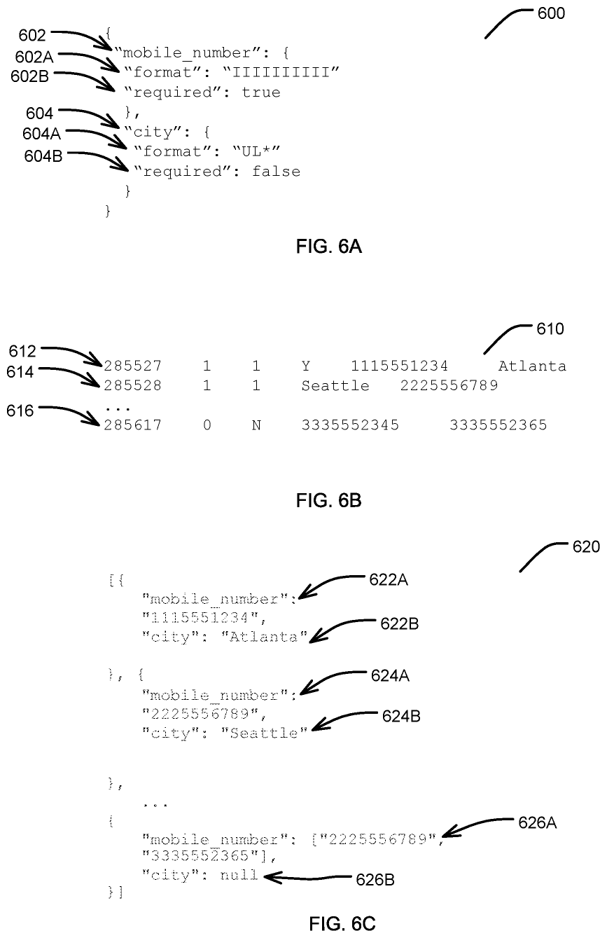

FIG. 6A illustrates a target schema 600 that the data of FIG. 6B is to be formatted into, using some embodiments of the technology described herein. As shown in FIG. 6A, the target schema 600 includes a mobile number field 602. The mobile number field 602 has a format 602A indicated by “1111111111” (i.e., a sequence of 10 digits). The mobile number field 602 further includes an indication 602B that the mobile number is required for each data entry. The target schema includes a city field 604. The city data field 604 has a format 604 indicated by “UL*”, which indicates an uppercase letter followed by any number of lowercase letters. The city data field 604 further includes an indication 604B that the city is not required for each data entry.

FIG. 6B illustrates an example of data 610 that is to be structured into the target schema 600 of FIG. 6A, according to some embodiments of the technology described herein. The data 610 includes a listing of information including a first row 612, a second row 614, and a third row 616. As shown in the example of FIG. 6B, rows 612 and 614 include city names, but do not organize the city names in the same order. Row 616 includes two phone numbers, but does not include any city name.

FIG. 6C illustrates data 620 obtained by formatting the data 610 of FIG. 6B into the target schema 600 of FIG. 6A, according to some embodiments of the technology described herein. For example, data 620 may be performed by performing process 300 on the data 610 of FIG. 6B. As shown in FIG. 6C, the data 620 includes a first mobile number entry 622A of “1115551234” obtained from row 612 of the data 610 shown in FIG. 6B. The data 620 includes a first city entry 622B of “Atlanta” obtained from row 612 of data 610 shown in FIG. 6B. The data 620 includes a second mobile number entry 624A obtained from row 614 of data 610. The data 620 includes a second city entry 624B of “Seattle” obtained from row 614 of data 610. The data 620 includes a third mobile number entry 626A of [“2225556789”, “3335552365”] obtained from row 616 of data 610. The third mobile entry 626A includes the two phone numbers from row 616 of data 610. The data includes 620 a third city entry 626B of “null” because the third row 616 of data 610 does not include a city. Accordingly, the data 620 does not include a third city entry.

FIG. 8 is a diagram illustrating an example structure of a system 800, according to some embodiments of the technology described herein. In some embodiments, string modification system 100 may include the system 800. In some embodiments, structure modification system 110 may include the system 800.

As shown in the example embodiment of FIG. 8, the system 800 includes an encoder 806 configured to encode an input 802. In some embodiments, the encoder 806 may be configured to encode the input 802 according to an encoding scheme to generate a set of features. Example encoding schemes are described herein. In some embodiments, the input 802 may be an input string (e.g., provided as input to string modification system 100). The encoder 806 may be configured to generate a set of features representing the input string. In some embodiments, the encoder 806 may be configured to output the set of features. For example, the encoder 806 may output a matrix, vector, or other suitable data structure storing the set of features.

In some embodiments, the input 802 may be a set of data (e.g., textual data) (e.g., provided as input to structure modification system 110). The encoder 806 may be configured to encode respective segments of the data to generate a respective set of features. For example, the encoder 806 may encode each line of the data into a respective set of features. In some embodiments, the encoder 806 may be configured to encode each segment of the data according to an encoding scheme to generate a corresponding set of features. For example, the encoder 806 may encode each line of textual data according to the encoding scheme to generate a set of features representing the line of textual data.

As shown in FIG. 8, in some embodiments, the encoder 806 may be configured to receive a target indication 804. In some embodiments, the target indication 804 may be a target format of a string. For example, the target indication 804 may be a specification of a format of a phone number in which an input string is to be formatted into. In some embodiments, the encoder 806 may be configured to generate a set of features representing the target indication 804. The encoder 806 may be configured to generate the set of features representing the target indication 804 by encoding the target indication 804 according to an encoding scheme. In some embodiments, the encoder 806 may be configured to encode the target indication 804 according to the same encoding scheme as one used to encode the input 802.

In some embodiments, the target indication 804 may be a specification of a target data structure in which input data 802 is to be organized into. For example, the target indication 804 may be a specification of a schema that the input data 802 is to be stored according to. The specification of the schema may include a definition of one or more data entities, each of which includes a respective set of one or more fields. The specification of the schema may further include a format for each of the field(s). An example target schema is described herein in reference to FIG. 6.

As indicated by the dotted lines outlining the target indication 804 in FIG. 8, in some embodiments, the encoder 806 may not receive a target indication 804. The machine learning model 808 may be trained to determine a modification without receiving any indication of a target. For example, the machine learning model 808 may be configured to output an indication of a modification without receiving input (e.g., input features) representing a target.

As shown in FIG. 8, the encoder 806 transmits a generated set of features to a machine learning model 808. The machine learning model 808 includes a transformer 808A configured to generate a latent representation of the set of features. In some embodiments, the transformer 808A may be a machine learning model. In some embodiments, the machine learning model may be a neural network. For example, the neural network may be a recurrent neural network (RNN), a convolutional neural network (CNN), a long short-term memory (LSTM) network, an auto encoder (AE), or other suitable type of neural network. In some embodiments, the latent representation may be a set of values output by a layer of the neural network.

As shown in FIG. 8, the machine learning model 808 includes a modification model 808B that receives the latent representation generated by the transformer 808A. In some embodiments, the modification model may be a machine learning model configured to output an indication of a modification to make to the input 802. For example, the modification may be a modification to one or more characters of an input string (e.g., removal, insertion, and/or moving of a character in the input string). In another example, the modification may be an indication of how to store a segment of input data. For example, the modification may be an indication of one or more fields in an output file (e.g., organized according to a target schema) in which input data is to be stored. In some embodiments, the modification model may be a neural network. For example, the neural network may be a CNN, RNN, LTSM, or other suitable type of neural network. In some embodiments, the modification model may be a support vector machine (SVM), decision tree, logistic regression model, or other suitable machine learning model.

As shown in FIG. 8, in some embodiments, the machine learning model 808 includes a context buffer 808C. In some embodiments, the context buffer 808C may be configured to store an indication of one or more previous modifications applied to an input. For example, the context buffer 808C may store an indication of one or more modifications applied to an input string. In another example, the context buffer 808C may store an indication of one or more fields of a schema in which previous input data segments were stored. The context buffer 808C may thus serve as memory of previous modification(s) determined by the machine learning model 808. In some embodiments, the context buffer 808C may store an indication of 1, 2, 3, 4, 5, 6, 7, 8, 9, 10, 15, 20, 25, 30, 35, 40, 45, or 50 previous modifications.

As indicated by the dotted lines around the context buffer 808C in FIG. 8, in some embodiments, the machine learning model 808 may not include a context buffer 808C. For example, the modification model 808B may be configured to generate an output indicating a modification without input indicative of previous modification(s) applied to the input.

As shown in FIG. 8, in some embodiments, the system 800 includes a Monte Carlo search simulation 810. The Monte Carlo search simulation 810 may be configured to determine an indication of a probability of different outcomes from applying a modification indicated by the output of the machine learning model 808 (e.g., determined by the modification model 808B). In some embodiments, the Monte Carlo search simulation 810 may be configured to simulate one or more modifications after the modification. For example, the Monte Carlo search simulation 810 may simulate a result of 1, 2, 3, 4, 5, 6, 7, 8, 9, or 10 modifications after the modification output by the machine learning model 808. The Monte Carlo search simulation 810 may determine different paths that the modifications may take, and a probability of success associated with each path. The system 800 may be configured to select one or more modifications based on the Monte Carlo search simulation that are indicated has having the highest probability of success. For example, the system 800 may determine modification(s) along a path with the highest probability of reaching a target string format or target structure in a threshold number (e.g., 5) of modifications. The system 800 may be configured to apply the determined modification(s) to the input 802 (e.g., string or data).

As indicated by the dotted lines around the Monte Carlo search simulation 810, in some embodiments, the system 800 may not include a Monte Carlo search simulation 810. For example, the system 800 may apply the modification indicted by the output of the machine learning model 808 to the input 802, without determining any modification from a Monte Carlo search simulation.

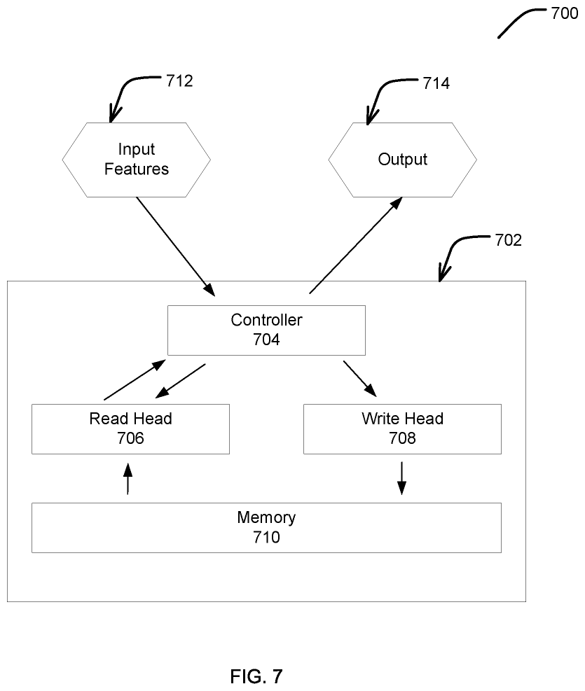

FIG. 7 is a block diagram 700 of a machine learning model, according to some embodiments of the technology described herein. The diagram 700 includes a machine learning model 702. The machine learning model includes a controller 704. In some embodiments, the controller 704 may be a neural network. For example, the controller 704 may be a recurrent neural network (RNN). As shown in the example of FIG. 7, the machine learning model 702 includes a memory 710. The memory 710 may be configured to store one or more previous inputs and/or outputs of the controller 704. For example, the memory 710 may store input and/or output vectors.

As shown in the example embodiment of FIG. 7, the machine learning model 702 includes a read head 706. The read head 706 may be configured to read data from the memory 710. For example, the read head 706 may be read vectors from a matrix of vectors stored in the memory 710. In some embodiments, the read head 706 may be configured to apply a weighting to the vectors read from the memory 710. For example, the read head 706 may apply a weighting to each of multiple vectors, where the weights across all the vectors sum to 1. As shown in the example embodiment of FIG. 7, the machine learning model 702 includes a write head 708. The write head 708 may be configured to write a current input and/or output of the controller 704 to the memory 710. For example, the write head 708 may write input and/or output vectors of the controller 704 to the memory 710. In some embodiments, the write head 708 may be configured to transform the vectors. For example, the write head 708 may compress vectors obtained from the controller 704 and write the compressed vectors into the memory 710.

FIG. 9 shows a block diagram of an example computing device 900 that may be used to implement embodiments of the technology described herein. The computing device 900 may include one or more computer hardware processors 902 and non-transitory computer-readable storage media (e.g., memory 904 and one or more non-volatile storage devices 906). The processor(s) 902 may control writing data to and reading data from (1) the memory 904; and (2) the non-volatile storage device(s) 906. To perform any of the functionality described herein, the processor(s) 902 may execute one or more processor-executable instructions stored in one or more non-transitory computer-readable storage media (e.g., the memory 904), which may serve as non-transitory computer-readable storage media storing processor-executable instructions for execution by the processor(s) 902.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A computing device for automatically formatting textual data, the computing device comprising:
an encoder to (i) obtain a first string comprising a first plurality of characters and (ii) generate a first set of features by encoding of the first plurality of characters according to an encoding scheme, wherein the first set of features is indicative of, for each character of the first plurality of characters, a character type and a character value; and
a string modification system to (i) input the first set of features to a machine learning model to generate output indicative of a first modification to the first string, and (ii) apply the first modification to the first string to generate a second string comprising a second plurality of characters.

2. The computing device of claim 1, wherein:
the string modification system is further to determine whether a stop criteria is met in response to application of the first modification; and
in response to a determination that the stop criteria is not met:
the encoder is to generate a second set of features by encoding of the second plurality of characters according to the encoding scheme; and
the string modification system is to (i) input the second set of features to the machine learning model to generate output indicative of a second modification to the second string, and (ii) apply the second modification to the second string to generate a third string.

3. The computing device of claim 1, wherein to generate the first set of features further comprises to perform a Monte Carlo tree search simulation to generate a simulated modification to the first input string and a score associated with the simulated modification, wherein the first set of input features is further indicative of the simulated modification and the score associated with the simulated modification.

4. The computing device of claim 1, wherein:
the encoder is further to obtain an indication of a target format for the input string; and
to generate the first set of features further comprises to generate the first set of features by encoding of the target format according to the encoding scheme.

5. The computing device of claim 1, wherein the first modification is selected from a plurality of modifications including removal of a character of the input string, insertion of a character into the input string, and moving of a character from one location in the input string to another location in the input string.

6. The computing device of claim 1, wherein to encode the first plurality of characters according to the encoding scheme comprises, for each character of the first plurality of characters, to assign a character type of a plurality of character types to the character.

7. The computing device of claim 6, wherein the plurality of character types comprises a numerical digit, a lowercase letter, an uppercase letter, a space, or a period.

8. The computing device of claim 6, wherein to encode the first plurality of characters further comprises, for each character of the first plurality of characters, to generate a vector that includes an indication of the character type assigned to the character and an indication of the character value of the character.

9. The computing device of claim 8, wherein the vector comprises a two-hot encoded binary vector including a first set bit indicative of the character type and a second set bit indicative of the character value.

10. The computing device of claim 1, wherein the machine learning model comprises a machine learning model trained to reformat phone number data or a machine learning model trained to reformat name data.

11. The computing device of claim 1, wherein the machine learning model comprises a Neural Turing Machine (NTM).

12. One or more non-transitory, computer-readable storage media comprising a plurality of instructions that in response to being executed cause a computing device to:
obtain a first string comprising a first plurality of characters;
generate a first set of features by encoding the first plurality of characters according to an encoding scheme, wherein the first set of features is indicative of, for each character of the first plurality of characters, a character type and a character value;
input the first set of features to a machine learning model to generate output indicative of a first modification to the first string; and
apply the first modification to the first string to generate a second string comprising a second plurality of characters.

13. The one or more computer-readable storage media of claim 12, further comprising a plurality of instructions that in response to being executed cause the computing device to:
obtain an indication of a target format for the input string; wherein
to generate the first set of features further comprises to generate the first set of features by encoding the target format according to the encoding scheme.

14. The one or more computer-readable storage media of claim 12, wherein the first modification is selected from a plurality of modifications including removal of a character of the input string, insertion of a character into the input string, and moving of a character from one location in the input string to another location in the input string.

15. The one or more computer-readable storage media of claim 12, wherein to encode the first plurality of characters according to the encoding scheme comprises, for each character of the first plurality of characters, to assign a character type of a plurality of character types to the character.

16. The one or more computer-readable storage media of claim 15, wherein to encode the first plurality of characters further comprises, for each character of the first plurality of characters, to generate a vector including an indication of the character type assigned to the character and an indication of the character value of the character.

17. A computing device for automatically formatting data into a target schema, the computing device comprising:
an encoder to (i) select a first portion of a first textual data, wherein the first portion comprises a plurality of characters, and (ii) generate a first set of features by encoding of the first portion according to an encoding scheme, wherein the first set of features is indicative of, for each character of the first portion, a character type and a character value; and
a structure modification system to (i) input the first set of features to a machine learning model to generate output indicative of a first modification to the first textual data, and (ii) apply the first modification to the first textual data to generate a second textual data in the target schema.

18. The computing device of claim 17, wherein to apply the first modification comprises to store the first portion in a first field of the second textual data, wherein the target schema is indicative of the first field.

19. The computing device of claim 17, wherein:
the encoder is further to obtain an indication of the target schema; and
to generate the first set of features further comprises to generate the first set of features based on the indication of the target schema.

20. The computing device of claim 19, wherein the indication of the target schema comprises an indication of at least one field in the target schema and an indication of at least one format for the at least one field.
